(19) United States
(12) Patent Application Publication
(10) Pub. No.: US 2005/0207576 A1
(43) Pub. Date: Sep. 22, 2005

(54) Method and apparatus for processing a stream that contains encrypted information

(75) Inventors: Albert Maria Arnold Rijckaert, Eindhoven (NL); Roland Peter Jan Mathijs Manders, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninkijke Philips Electronic N.V.

(21) Appl. No.: 10/517,477

(22) PCT Filed: May 21, 2003
(86) PCT No.: PCT/IB03/02159

§ 371 Date: Dec. 7, 2004

(30) Foreign Application Priority Data
Jun. 12, 2002 (EP) 02077292.7

(51) Int. Cl. H04N 7/167

(52) U.S. Cl. 380/210; 382/232

(57) ABSTRACT

Video information is transmitted encrypted as part of a video stream, so as to provide conditional access to the video information. The video stream comprising mutually interspersed first and second subsets of the image frames. The information for the image frames of the first subset is encrypted. A stream is broadcast (10) that contains, interspersed with one another, the information for the first subset in encrypted form and the information for the image frames of the second subset at least partly in plain form. This permits receivers (12) to detect the unencrypted parts without decryption and to generate and store pointer information (124) to the unencrypted parts. The pointer information can be used later for the purpose of trick play (126) at the receiver.

The invention relates to a method of processing image information.

From European Patent Application No. 1122728 it is known to transmit an encrypted video information stream and to store this information in encrypted form in a storage medium. Storage of the stream enables trick play such as for example fast forward playback, reverse playback etc. For trick play it suffices to access selected parts of the stored video information.

To support trick play, management information is extracted from the video information stream. The management information contains pointers to certain locations in the video information that may have to be accessed during trick play. In the case of an MPEG stream for example, this involves pointers to the locations that contain I-frames (frames that are coded independent of other frames). The relevant locations are detected when the video information stream is received. In the case of an encrypted stream of information, however, detection of the relevant locations requires decryption of the stream. Thus, computational resources for decryption have to be occupied for storage of streams of video information. This reduces the availability of these resources for other purposes, for example for decryption during replay, and may ultimately require the inclusion of additional computational resources in a replay apparatus. In addition, a decryption key has to be available during storage. This may be undesirable, for example if another key is needed at that time for replaying information.

Amongst others it is an object of the invention to reduce the amount of computational resources needed for supporting trick play of video information from a received and stored stream of video information.

Amongst others, it is a further object of the invention to reduce the amount of computational resources without requiring additional information to be included in the stream of video information especially for the purpose of allowing trick play.

Amongst others, it is another object of the invention to make it possible to prepare information that can be used for purposes such as trick play without need to decrypt.

The invention provides for a method according to claim 1. According to the invention intermittent parts of the stream of video information are in unencrypted form. In particular, selectively those parts that are needed for determining pointers to locations that may be needed during trick play are preferably in unencrypted form. This makes it possible for a recording or replay device to detect the content of these parts without decrypting the stream. Conventional properties of the stream are used to identify the relevant parts of the stream. No new matter need be added to the stream for this purpose.

Preferably packets of information that contain the start of independently coded video frames (I-frames) are in unencrypted form. More preferably packets that contain a remainder of the I frames are in encrypted form. Thus, the stream cannot be used to extract an unencrypted “slide-show”. Also, during trick play, the latency of replay can be reduced because, when replay jumps to a packet pointed at by a pointer, processing of that packet can start immediately, without waiting for decryption. Also preferably packets that contain the end of the I-frames are in unencrypted form. This makes it possible to detect the end of the I-frames without decrypting the stream.

Preferably the packets that are at least partially in unencrypted form are selected and used to make a separate trickplay stream.

These and other advantageous aspects of the method, system and apparatus according to the invention will be described in more detail using the following figures

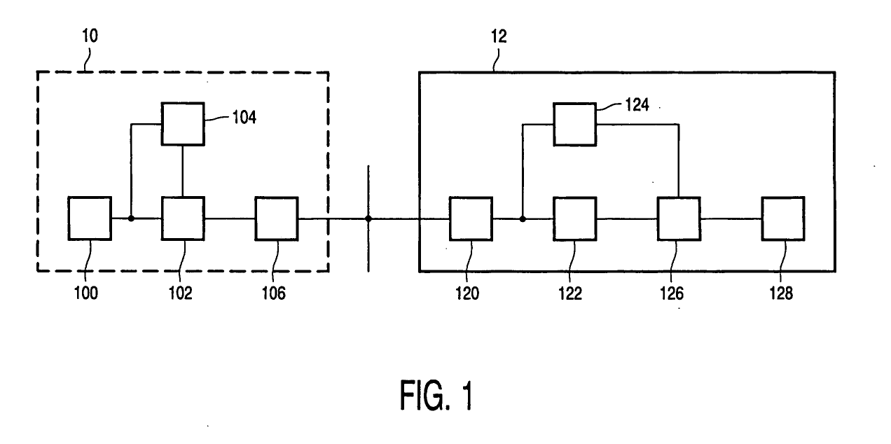

FIG. 1 shows a system for processing a video stream;

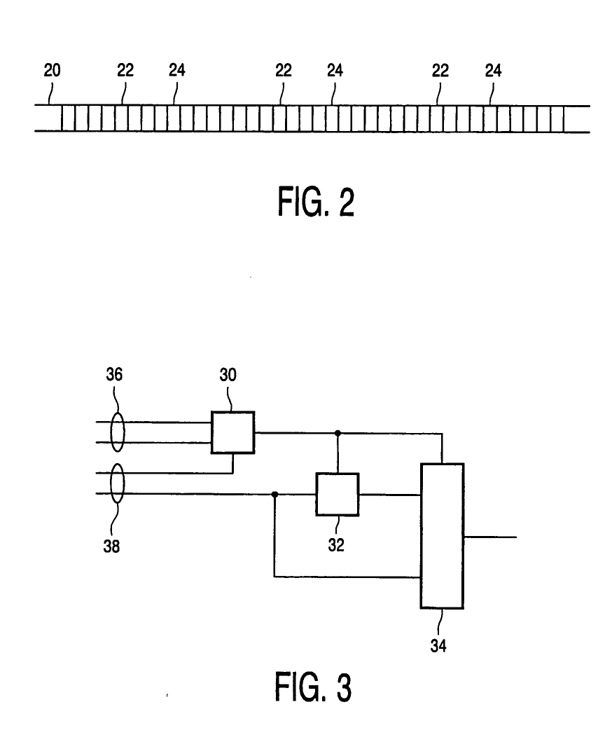

FIG. 2 illustrates a video stream; and

FIG. 3 sows a replay unit.

FIG. 1 shows a system for processing a video stream. The system contains a transmitter apparatus 10 and a receiver apparatus 12 coupled to each other. The coupling may be realized for example via a cable network or via wireless transmission. A plurality of receiver apparatuses 12 may be coupled in parallel to the transmitter apparatus 10. Transmitter apparatus 10 contains a video stream source 100, an encryption unit 102 and a transmission unit 106 in cascade and an encryption controller 104 with an input coupled to an output of source 100 and an output coupled to a control input of encryption unit 102. Reception apparatus 12 contains a receiving unit 120, a storage device 122, a replay unit 126, a display device 128 and a detection unit 124. The receiving unit 120 has an input coupled to transmitter apparatus 10 and an output coupled to storage device 122. Replay unit 126 has an input coupled to storage device 122 and an output coupled to display device 128. Detection unit 124 has an input coupled to the output of receiving unit 120 and an output coupled to replay unit 126.

In operation, source 100 produces a stream of unencrypted video data. The video data encodes a succession of video frames, encoded for example according to the MPEG standard. MPEG frames are encoded in a known way as I-frames, P-frames and B-frames. P-frames and B-frames are encoded as updates to other frames (ultimately as updates to I-frames, but also as updates to other P-frames or B-frames). Each I-frame is encoded independently, not as update to other frames. The frames are included in packets of information. Information that encodes a frame is usually distributed over a plurality of packets. Encryption unit 102 encrypts at least part of the packets of the stream of video data and passes the stream to transmission unit 106, which broadcasts the stream. The packets form the units of encryption, i.e. each packet is encrypted independently of other packets. Encryption unit 102 enters information into the packet to indicate whether the packet has been encrypted.

Encryption controller 104 detects packets that contain the start of independently encoded frames in the stream produced by source 100, for example of I-frames in the case of MPEG encoding. These independently encoded frames will generally be referred to as I-frames in the following, but it will be understood that the invention applies to other types of stream them MPEG streams as well. Preferably, encryption controller 104 also detects packets that contain the ends of these I-frames. In response to detection encryption controller 104 controls whether encryption unit 102 encrypts the corresponding packet. A packet is not encrypted when it contains the start of an independently encoded frame. Otherwise all packets with video information are preferably encrypted, preferably except packets that contain the ends of independently encoded frames.

FIG. 2 illustrates a video information stream 20 produced by transmitter apparatus 10. The stream contains a succession of packets of information, shown separated from each other by partitions. Most of the packets in stream 20 contain encrypted information, but some of the packets 22, 24 contain unencrypted information, first packets 22 containing starts of I-frames, second packets 24 containing ends of I-frames. It should be appreciated that there is no fixed distance between successive starts of I frames, or between the starts and ends of these frames, because the video information is generally compressed.

Receiver apparatus 12 receives the packets and stores them in storage device 122. Detection unit 124 detects whether the received packets are encrypted or not. If a packet is not encrypted, detection unit 124 inspects whether the packet contains the start of an independently encoded frame. If so, detection unit 124 records information pointing at the packet in the stream. This pointing information may be in the form of an address of a memory location in storage device 122, or in any other form that permits addressing in order to retrieve the packet. Detection unit 124 may store the pointing information internally, but of course, as an alternative, the pointing information may be stored externally, for example in storage device 122.

Detection unit 124 may perform detection of packets with starts and ends of frame by testing for the picture header start code of MPEG frames for example. In MPEG the picture header start code is 00000100 (hexadecimal). Detection of encryption may be performed using the scrambling bits in the packets. In MPEG scrambling bit values 00 indicate an unencrypted packet. It will be appreciated that in this way information that can be encoded in conventional MPEG streams to signal encryption, starts of frames etc. is now used to facilitate detection of the start and end of selected frames without decryption and without removing all access protection. That is, no additional bits have to be added to the stream to facilitate detection of the start and end of frames. In principle detection unit 124 can perform detection whether the packet contains a start of an I-frame by parsing the information in the packet. Detection may even be made easier by indicating the start of I-frames when the transmitter apparatus 10 sets the Payload Unit Start Indicator bit of packets that contain the start of I-frames. In this case detection unit 124 does not even need to parse the packets to detect the start of I-frames.

During replay, replay unit 126 retrieves the packets from storage device 122 and decrypts the packets if necessary. The decrypted packets are supplied to display device 128, which reconstructs the video information from the encoded packets and displays the reconstructed video information. Of course, the display device, or at least a display screen of the display device may also be externally attached to receiver apparatus 12.

In trick mode replay, replay unit 126 selects a temporal pattern in which the encoded frames must be displayed, for example each time skipping a number of frames in a fast forward mode, or in reverse order. Once it has selected a frame to be displayed (or a frame number of that frame) replay unit 126 retrieves the pointing information for that frame from detection unit 124 (or from wherever the pointing information has been stored). Replay unit 126 uses the retrieved pointing information to retrieve the frame selectively from storage device 122.

FIG. 3 shows an embodiment of replay unit 126. Replay unit 126 contains a frame selection unit 30, a decryption unit 32 and a multiplexer 34. Frame selection unit 30 has a first interface 36 to detection unit 124 (not shown) for signalling required frames and receiving back pointing information. Frame selection unit 30 has an output coupled to a second interface 38 to storage device 122 (not shown) for outputting commands to retrieve packets starting from a storage location pointed at by the pointing information. A packet input of the second interface 38 is coupled to respective inputs of multiplexer 34, directly and via decryption unit 32. Multiplexer 34 is controlled by selection unit 30 and has an output coupled to the display device (not shown).

In operation frame selection unit 30 selects the frames that will be displayed, as appropriate for the relevant trick mode. Frame selection unit 30 retrieves the pointer information to the starts and ends of these frames from the detection unit and commands the storage device to retrieve successive packets starting from the start of the frame and ending at the end of the frame. Multiplexer 34 supplies the retrieved packets to the display device, the packet that contains the start of the frame directly, subsequent packets via decryption unit 32. Because the packet that contains the start of the frame does not need to be decrypted this packet is supplied to the display device without the latency caused by decryption. For subsequent packets this latency is not critical since their retrieval is commanded sufficiently in advance to allow for decryption.

Although the invention has been described for the case that the start and end of frames can be detected from information in individual packets, it will be understood that as an alternative the starts and/or ends may also be detected from information in pairs of successive packets. In this case, such pairs of successive packets are in unencrypted form, preferably dependent on whether an individual packet contains sufficient information to detect a start and/or end. Similarly, detection unit 124 uses information from such pairs if needed.

The stream 20 as described with reference to FIG. 2 is also very useful for the construction of separate trickplay streams with encrypted I-frames. For this purpose I-frames are selected from the normal play stream 20, extended with a number of empty P-frames and the resultant trickplay GOP's are concatenated. There is no need to encrypt the empty P-frames.

In order to get an MPEG compliant trickplay stream some changes have to be made to this trickplay stream. First of all the last packet has to be cleaned up in the sense that possibly present information from the next P- or B-frame has to be removed. Moreover, some information in the header has to be changed like for instance the presentation time stamp. The packets where the changes have to be made are exactly the packets 22, 24 which are unencrypted. Thus, construction of the trickplay stream is now much simpler because there is no need for decryption of the normal play stream when constructing the trickplay stream.

The trickplay stream may need the addition of a PCR time base and the addition of ECMs. This could be done according to an algorithm as given in European patent application 02080633.7 (attorney docket PHNL021462).

The completed trickplay stream can then be sent to the device 12 for decryption and decoding. Because no encryption needs to be done in the storage device, no smartcard or keys or decrypter need to be present in this storage device, which makes it more independent from the providers and better suited for the horizontal market.

There is a slight difference in the requirements for the plaintext packets 22, 24 used in extraction of pointer information and for the plaintext packets used for construction of the separate trickplay stream. In the first case only those packets need to be plaintext that contain the picture header. In the latter case all packets where changes need to be done must be in plaintext. Without detailing which information has to be changed this generally means that at the start of the GOP (I-frames) those packets have to be plaintext containing the information starting at the GOP start up to and including the picture header of the I-frame. At the end of the I-frame there is no difference in the requirements.

Although in theory there is no limitation to the size of the GOP start, in practice this is not more one or two packets which means that only the packets 22, 24 are needed in plaintext format for the construction of the separate trickplay stream. Thus usually no extra packets will need to be provided in unencrypted form.

1. A method of processing information that encodes a video stream (20) of image frames, the video stream comprising mutually interspersed first and second subsets of the image frames, the method comprising
encrypting the information for the image frames of the first subset;
producing a stream that contains, interspersed with one another, the information for the first subset in encrypted form and the information for the image frames (22, 24) of the second subset at least partly in plain form.

2. A method according to claim 1, wherein selected parts of the second subset that enable access to the stream for the purpose of trick play are in unencrypted form.

3. A method according to claim 2, wherein the information encodes each particular frame of the second subset independent of the frames other than that particular frame.

4. A method according to claim 3, wherein the stream contains packets, information from at least a particular frame being distributed over a plurality of the packets, the information being in unencrypted form in a first one of the plurality of the packets that contains a start of the particular frame, subsequent packets of the plurality containing at least part of a remainder of the information from the particular frame in encrypted form.

5. A method according to claim 4, wherein the information from the particular frame is in unencrypted form in a final one of the plurality of the packets that contains information from the particular frame.

6. A method according to claim 1, comprising
selecting the information for the image frames of the second subset, and
producing a separate trickplay stream that contains the selected frames.

7. A reception and replay apparatus (12) for receiving a stream that contains packets with information that encodes a stream of image frames partly in encrypted form, the apparatus comprising
a reception unit (120) for receiving the packets;
storage unit (122) for storing packets received by the reception unit;
a detection unit (124) for detecting for each particular packet whether packet is in unencrypted form and storing a pointer to the particular packet conditional on detection that the particular packet is in unencrypted form;
a retrieval unit (126) for controlling selective retrieval of the particular packet from the storage unit under control of the pointer.

8. A reception and replay apparatus (12) according to claim 7, wherein the detection unit (124) is arranged to process information from the packets that are received in unencrypted form to determine whether the packet contains a start or end of a frame and to store the pointer conditional on said determination.

9. A transmitter apparatus (10) arranged to perform the method of claim 1.
